(19) United States
(12) Patent Application Publication
(10) Pub. No.: US 2016/0156501 A1
(43) Pub. Date: Jun. 2, 2016

(54) NETWORK APPARATUS WITH INSERTED MANAGEMENT MECHANISM, SYSTEM, AND METHOD FOR MANAGEMENT AND SUPERVISION

(71) Applicant: ADVANTECH CO., LTD., TAIPEI (TW)

(72) Inventors: PIN-CHIEH HSU, TAIPEI CITY (TW); HUNG-CHOU CHEN, TAIPEI CITY (TW)

(21) Appl. No.: 14/556,041

(22) Filed: Nov. 28, 2014

(51) Int. Cl. H04L 12/24; H04L 12/26

(52) U.S. Cl. CPC H04L 41/046; H04L 43/10

(57) ABSTRACT

The disclosure is related to a network apparatus with inserted management mechanism, a system, and a method for management and supervision. The network apparatus is such as a non-manageable network facility. In addition to the original circuit modules, the network facility further includes an inserted management unit for rendering management or supervisory functions. The inserted management unit exemplarily includes an inserted program unit for storing management and supervisory programs, and an inserted data processing module for processing the signals. The inserted program unit has a program loading module and a software driving module. When the system receives a signal indicative of initiating one or more program modules, the program driving module is called to initiate the program modules on demand. The inserted program unit includes a management module for rendering the management mechanism, and a supervisory module for rendering the supervisory mechanism.

### BACKGROUND

1. Technical Field

The present invention is generally related to a network apparatus, system, and its method of management and supervision; in particular, to the system and method introducing an inserted management mechanism applied to the non-manageable network facility, which is originally without management and supervisory functions.

2. Description of Related Art

A supervisory mechanism may be introduced within a network system, especially an industrial-grade network system. A supervisory host is incorporated to perform a specific communication protocol in order to acquire operational information of every network node. The network node is such as a network router, network switch, or the other types of network facilities. Further, the computer systems and the industrial equipment disposed at the plant are generally regarded as the network nodes. If any network node is functioning with supervision, the supervisory host may acquire the operational status from the network node. For example, for the purpose of supervision for an industrial plant, some sensors for acquiring information of ambient temperature, gas leaks and whether the proper functioning of the instrument and operational condition of equipment may be disposed. The supervisory mechanism is for avoiding worst events by timely treatment for abnormal operation.

However, when any node within a network system does not have a supervisory mechanism, the supervisory host fails to acknowledge its condition, and judgment of abnormal operation may be limited. For example, in an emergency, the devices around the node without the supervisory function must be referred to in order to determine whether or not the node is in an abnormal condition; or in some cases the plant is required to send staff to the location having the problem.

In conventional technology, a supervisory control and data acquisition system (SCADA) has been developed to collect information of node devices within a network with a specific protocol. The protocol is such as a serial communication protocol like Modbus. Under the protocol with supervisory control and data acquisition system, a supervisory system is disposed for collecting information. Every node may feedback information to the supervisory system under the specific protocol. The supervisory control and data acquisition system is able to supervise the whole network system.

Furthermore, a mechanism called network management system (NMS) may also be incorporated to supervise the network system. The related network system is disposed with this NMS for performing the supervision over a simple network management protocol (SNMP). When the node device is installed with the supervisory mechanism in compliance with SNMP, the network management system is allowed to retrieve operational information of the node device.

However, because there are still some devices within the network system that are not installed with the circuit of supervisory mechanism, the supervisory host will not have the information therefrom. The whole network system therefore fails to be supervised.

### SUMMARY

In view of the supervisory host failing to supervise every device especially the non-manageable network apparatus within the system, a method and a system with inserted management mechanism in accordance with the present invention are provided for the non-manageable network apparatus. One of the objectives of the invention is to provide a plug-in inserted management or supervisory mechanism to the non-manageable network apparatus. The plug-in mechanism allows the management host or supervisory host to successfully acquire information from the non-manageable network apparatus.

In one exemplary embodiment, a network apparatus with the inserted management mechanism is provided. The network apparatus may be originally a non-manageable network apparatus. The network apparatus at least includes a micro-controlling module, an input-output interface module rendering a connection within the network, a network module processing a specific communication protocol, a memory module, and a power management module.

The network apparatus is exemplarily disposed with an inserted management unit, which is a hardware or software-implemented module. The inserted management unit is connected with the original circuits of the network apparatus. The inserted management unit includes an inserted program unit storing a management and supervisory program, and an inserted data processing module for processing the management and supervisory data.

The inserted program unit has a program loading module and a software driving module. The software driving module is called to initiate one or more program modules in response to a signal of ready to initiate the program module.

In one further embodiment, the program module includes a management module. The management module is used to render a remote management service for the non-manageable network apparatus. The remote management service allows the non-manageable network apparatus to be with remote management function. The program module also includes a supervisory module. The supervisory module is used to provide an inserted supervisory function for the non-manageable network apparatus. The supervisory module includes at least one supervisory protocol module in compliance with at least one supervisory protocol.

The disclosure is related to a network system for rendering the inserted management mechanism. The network system includes a management host, a supervisory host, and at least one network apparatus embedded with the inserted management mechanism. The hosts and the network apparatus are interconnected over a network. The management host is installed with a management program executed to initiate a management interface for the management of network apparatus. The supervisory host has a supervisory program allowing the apparatus to comply with a protocol of supervisory control and data acquisition system and/or a protocol of simple network management.

According to one of the embodiments of the present invention, in the beginning, a network system having the network apparatus with the inserted management mechanism is activated. By the inserted management mechanism, the management module or/and the supervisory module are loaded in the network apparatus. In the meantime, the network apparatus responds the message sent from the host which actively broadcasts the related signals.

The management host acquires management identification information from the network apparatus with inserted management mechanism over the network. The management identification information is provided for the network apparatus identifiable by the management host. A management mode is launched after the connection is established. Next, the supervisory host performs supervision over the network apparatus loaded with the inserted supervisory protocol module according to the management identification information.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

FIG. 1 shows a framework diagram depicting a supervisory control and data acquisition system;

FIG. 2 shows a framework diagram depicting a network management system;

FIG. 3 shows a schematic diagram depicting a network apparatus with an inserted management mechanism in one embodiment of the present invention;

FIG. 4 shows a circuit block diagram depicting the network apparatus with the inserted management mechanism in one embodiment of the present invention;

FIG. 5 shows a functional block diagram depicting an inserted program unit in the network apparatus with the inserted management mechanism in one embodiment of the present invention;

FIG. 6 shows a flow chart describing a method for management and supervision according to one embodiment of the present invention;

FIG. 7 shows another flow chart describing the method for management and supervision according to one embodiment of the present invention.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

Supervisory control and data acquisition system (SCADA) is generally used to acquire operational status of every node device in a network system. The system can be operated over an Ethernet network, or a specific network system. SCADA may be built as an uppermost node within the network system. SCADA performs a supervisory program to collect data from every node device within the network system. The node device is installed with a program module in compliance with a protocol of the supervisory control and data acquisition system. The protocol is such as Modbus which is a serial communication protocol provided for the host with SCADA to collect data over the network.

A supervisory system can be established under this protocol of the supervisory control and data acquisition system. For example, a remote terminal unit (RTU) is settled to link with various sensors used to retrieve data over the network. A programmable logic controller (PLC) may be an inner circuit to collect data within the system. The operation of supervisory control and data acquisition system may be performed by the RTU or PLC. The main system acts as a supervisory controller. The PLC or RTU may feedback the operational data to the supervisory control and data acquisition system that is allowed to perform supervision over the whole system.

The node device may be one of the various types of network devices or computer systems, instruments and equipment for some specific places. The operational data acquired by the supervisory control and data acquisition system is such as an address to locate the device, operating temperature, switch control, gas concentration, and/or the like. The supervisory control and data acquisition system is able to acknowledge the operational information for the devices within the system. The information is referred to in order to determine if any device is in malfunction and its address.

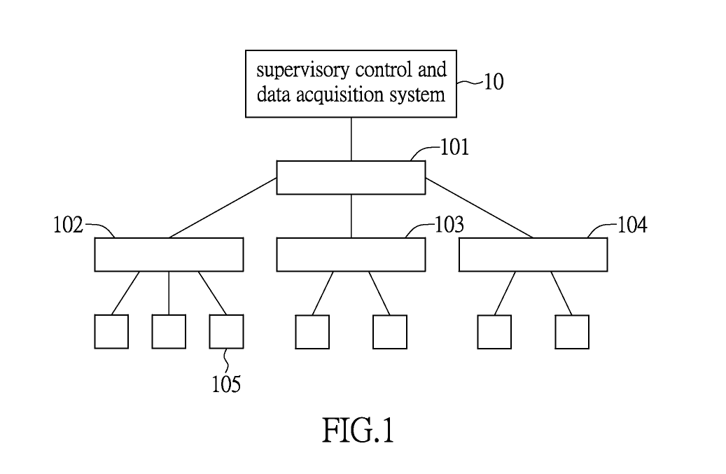

The framework related to the supervisory control and data acquisition system for collecting information of node devices is exemplarily referred to FIG. 1. A supervisory control and data acquisition system 10 is shown. The system 10 is connected with multiple node devices (101, 102, 103, 104, and 105). For example, the node device 105 is such as a terminal facility. If the node device is installed with the management mechanism in compliance with the supervisory control and data acquisition system 10, the node device is able to be supervised, for example being the RTU, PLC. The supervisory data of each node is actively sent to the supervisory control and data acquisition system 10.

However, when any node device, e.g. 102, 103, or 104, is not installed with the management mechanism, the node device cannot be supervised by this system 10. That means the supervisory control and data acquisition system 10 fails to acquire any information from those kinds of node devices (102, 103, and 104). The approach in the method in accordance with the present invention is introduced to the network system with the non-manageable devices. The node device is embedded with an inserted supervisory mechanism being visible to the supervisory control and data acquisition system 10. The operational information of the node devices 102, 103, and 104 are therefore acquirable.

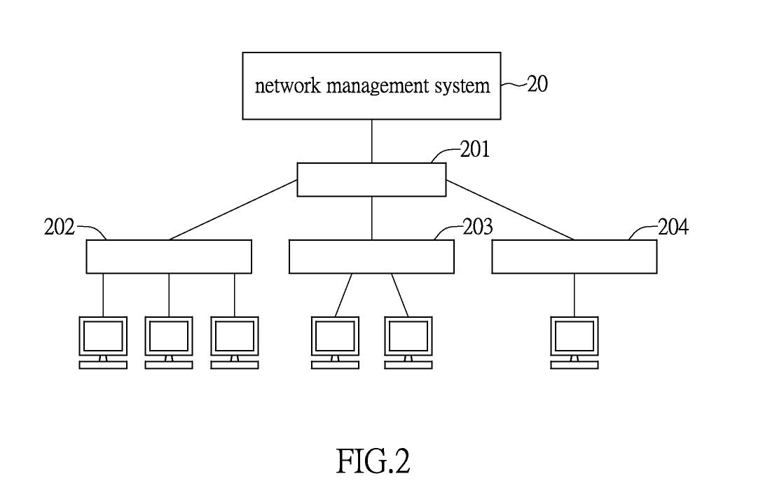

A network management system (NMS) may be utilized to perform the supervision over the network system. The related system is exemplarily referred to FIG. 2 showing a schematic diagram of network framework.

The network management system 20 adopts a simple network management protocol (SNMP). Over SNMP, the various node devices within the network system can be supervised. The node devices are such as a router 201, network switches 202, 203, 204, and other terminals. The node device is required to be installed with a management program under the management mechanism, then allowing the network management system 20 to acquire its operational data.

When any node device within the network system is not equipped with the management mechanism, the network management system 20 fails to acquire any information from the kind of non-manageable node device. The approach of the present invention is introduced to embed an inserted supervisory mechanism to the node device. The inserted supervisory mechanism allows the network management system 20 to acquire the data from the node device which is originally without any supervisory function.

According to a network apparatus with the inserted management mechanism, a method of management and supervision is introduced. One of the objectives of the method is to incorporate a supervisory hardware, software, or firmware module into the non-manageable network apparatus. For an exemplary example, a circuit module with management and supervision function is introduced to the apparatus. Further, a software module or firmware module rendering the management and supervision function may also be used in the apparatus. In an exemplary example, a new circuit assembly may be embedded to the non-manageable network apparatus. The circuit assembly may be implemented as a chipset, burned firmware, or installed software.

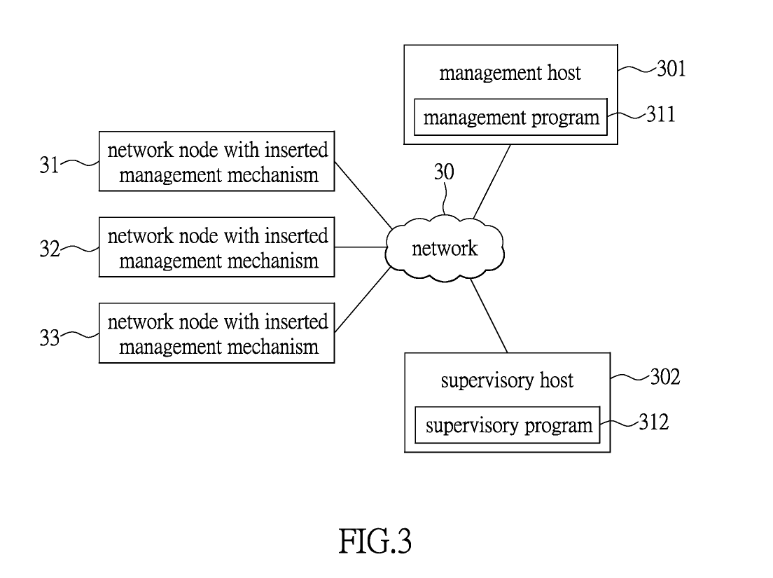

A network system with an inserted management mechanism according to the present invention is provided. The system provides a management means, a supervisory means, and at least one network apparatus with the inserted management mechanism. The at least one network apparatus is connected with a facility performing the management means and the supervisory means over a network, referring to FIG. 3. The network system with inserted management mechanism may be exemplarily implemented by a standalone management host 301 rendering the management function, and another standalone supervisory host 302 rendering supervisory function. Network apparatuses 31, 32, and 33 with the inserted management mechanism are shown connected with the management host 301 and the supervisory host 302 over a network 30.

In the network apparatus and the related system, the inserted management mechanism allows the network system to manage the various apparatuses over multiple connections. Via the network 30, the management host 301 uses a management program 311 provided for the system administrator to perform management by initiating a management interface. The management interface may be a webpage, graphical user interface, or a command-line protocol such as Telnet. Under this management mechanism, when the network nodes 31, 32, 33 are embedded with an inserted management mechanism, the nodes 31, 32, 33 can initiate corresponding management program 311 allowing the management host 301 to actively or passively perform the management there-between. The management host 301 may accordingly scan the information delivered over the network 30 by means of broadcast. The management host 301 can recognize these network nodes 31, 32, 33 by their broadcasted management identification information, and then allocate network addresses such IPs to the network nodes 31, 32, 33.

The supervisory host 302 provides a supervisory program 312. The supervisory program 312 is provided for the administrator of the supervisory host 302 to configure the nodes 31, 32, 33 to be actively or passively supervised. The supervisory host 302 acquires the operational data of network nodes 31, 32, 33 according to the network addresses of the nodes with the inserted management mechanism over the network 30. The supervisory data is collected over a protocol such as Modbus for the supervisory control and data acquisition system, and/or over a simple network management protocol (SNMP).

It is worth noting that the management host 301 and the supervisory host 302 are two separate systems which are respectively responsible for two individual operations. The configurations for the network apparatuses within the same network system may also be separate. Furthermore, even though the two individual systems perform the separate operations, the supervisory host 302 may obtain the network addresses of the network nodes 31, 32, 33 from the management host 301.

According to one more embodiment, the management means originally performed by the management host in the network system with inserted management mechanism may be a software module installed in a computer system. Further, the management means may be a software or firmware means installed in one specific node in the network system. Similarly, the supervisory means may also be the module installed in a computer system, or a software or firmware module installed in any network node within the network system.

The terminal nodes may have devices with the supervisory mechanism, and also non-manageable network apparatus(es). The supervisory host can determine failure from the information around the abnormal apparatus since the host fails to obtain any information directly from the apparatus, e.g. the non-manageable network apparatus, when it meets malfunction. This situation relies on manual operation to check the problem. Thus, when the approach according to the present invention is introduced to the non-manageable network apparatus, the network apparatus is able to be remotely managed or supervised. The shown network nodes 31, 32, 33 are exemplified by embedding the inserted management mechanism.

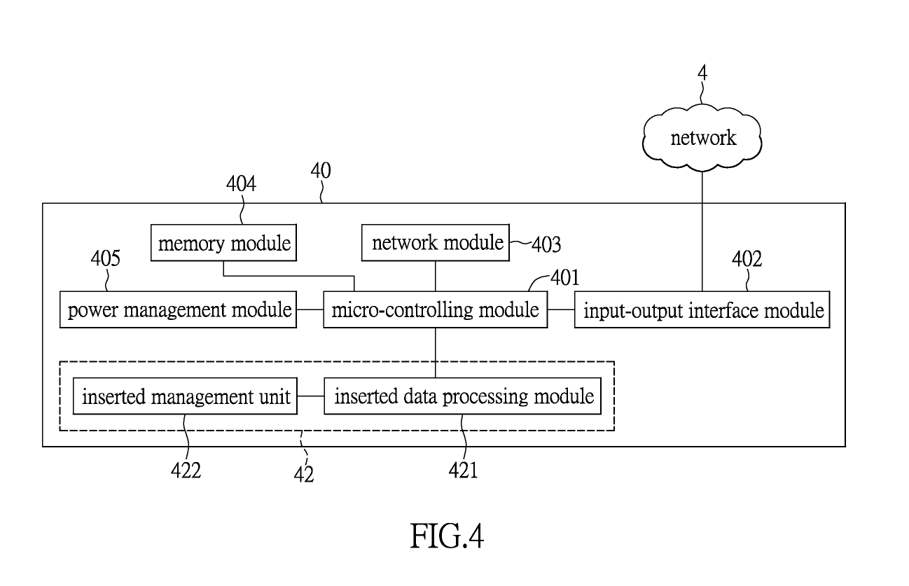

The embodiment of the network apparatus with the inserted management mechanism is referred to in the circuit block diagram shown in FIG. 4.

The network apparatus 40 has its original circuit elements such as a micro-controlling module 401, an input-output interface module 402, a network module 403, a memory module 404, and a power management module 405. An inserted management unit 42 is particularly introduced in the network apparatus 40 when it uses the inserted management mechanism. The inserted management unit 42 includes the primary elements such as an inserted program unit 422 used to store a management and supervisory program, and an inserted data processing module 421 used for processing management and supervisory data.

Exemplarily, the inserted management unit 42 may be implemented by software or firmware scheme, or alternatively inserted with a circuit module for implementing the management and supervision.

The network apparatus 40 has its original micro-controlling module 401 for processing the internal signals. The network apparatus 40 is such as a router, a network switch, or a device rendering a specific function. The input-output interface module 402 used to render an input/output interface is electrically connected with the micro-controlling module 401. For example, when the network apparatus is a router or network switch, the input-output interface module 402 provides more interfaces to connect with other network apparatuses. The network module 403 is electrically connected with the micro-controlling module 401. The network module 403 is a firmware or hardware module for conducting a specific communication protocol over a network framework.

Under a normal condition, the memory module 404 electrically connected with a micro-controlling module 401 is used to be a main memory or inner storage for the network apparatus 40. The storage is used to store requisite operating system program, and the tools. Further, when the network apparatus 40 is installed with the inserted management mechanism, the storage stores the related programs. The power management module 405 is electrically connected with the micro-controlling module 401. The power management module 405 is used to manage allocation of the power supplied to the circuit modules of the network apparatus 40. The power management module 405 is able to achieve the requirement of power saving.

The inserted management unit 42 for the non-manageable network apparatus 40 may be exemplified by inserting a program, firmware, or hardware for rendering remote management and supervision. The primary elements of the inserted management unit 42 are such as the inserted program unit 422 used to store a management and supervisory program, and the inserted data processing module 421 for processing data in the apparatus.

The inserted management unit 42 may be a software module installed in the network apparatus 40. The circuit module may be a chipset which is electrically connected to the inner circuit. For example, the chipset is electrically connected with the micro-controlling module 401, e.g. the interconnection between the inserted data processing module 421 and the micro-controlling module 401.

Furthermore, the inserted management unit 42 may also be an integrated circuit, in which the inserted data processing module 421 may be integrated with the micro-controlling module 401 by a circuit module. In an exemplary embodiment, a System on Chip (SoC) structure is incorporated to provide a chip to integrate the circuits of the micro-controlling module and the inserted management unit 42.

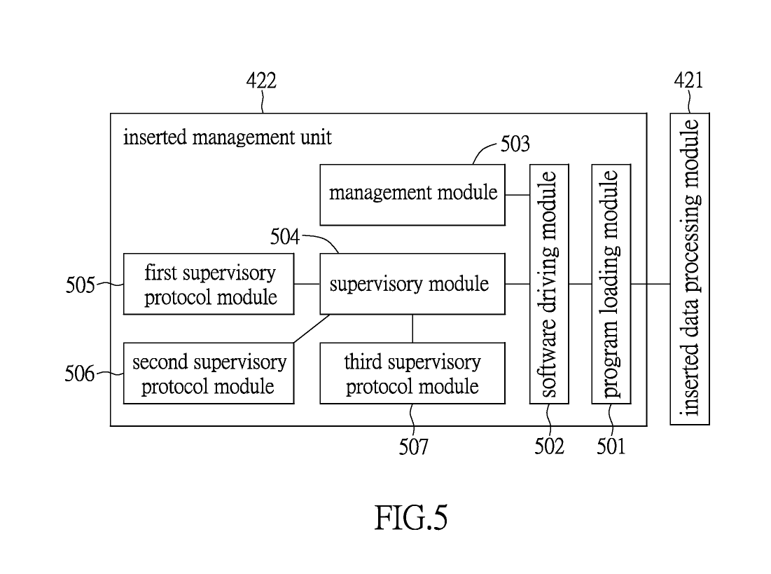

Reference is made to FIG. 5 showing a functional block diagram describing the inserted program unit of the network apparatus with inserted management mechanism.

The inserted management unit 42 exemplarily includes the inserted program unit 422 which is such as a memory circuit for storing the instructions and codes of management and supervision. After initiating the program, the instructions and codes are loaded to the inserted data processing module 421.

The inserted program unit 422 includes a program loading module 501 and a software driving module 502. When the program loading module 501 receives a signal of ready to initiate one or more program modules, the software driving module 502 is called to initiate the one or more program modules. The program module includes a management module 503 allowing initiating the management module 503 by the software driving module 502. The program module includes a management module 503 used to provide the non-manageable network apparatus with a remote management service which allows the non-manageable network apparatus to be with remote management function.

After initiating the management service, reference is made to FIG. 3, the management host (301) is able to exchange messages with the management program (311) of the network apparatus. The administrator is allowed to perform remote management via a management interface initiated by the management host (301). In one embodiment, the management module 503 installed in the network apparatus provides the service of remote configuration and access. The management host (301) is configured to install a remote management tool program corresponding to the management module 503. The management host (301) is therefore allowed to access and manage the network apparatus. When the network apparatus is activated, the management host is able to collect data from the network apparatus and register the apparatus via broadcasting or a specific method.

Still further, the management host (301) is able to actively scan the network nodes within a network section. When a remote management tool program is executed in the host, the network apparatus with supported inserted management mechanism can be found by broadcasting the network. In addition to installing the remote management tool program to the management host (301) within the network section, the program may also be installed in any existed host, namely the other type of device installed with this management and supervisory mechanism. The other type of device is such as a gateway device, router, or network switch in the network. The device installed with the remote management tool program acts as a management host within the network section for managing other non-manageable network apparatus with the inserted management mechanism.

In a condition for requiring supervisory function, the inserted program unit 422 initiates the supervisory module 504 by the software driving module 502 for activating the system. The program loading module 501 then loads the related instructions or codes to the inserted data processing module 421.

The program module further includes a supervisory module 504, which is used to provide the non-manageable network apparatus an inserted supervisory function. The supervisory module 504 supports at least one supervisory protocol. As shown in the figure, at least one supervisory protocol module is installed. The supervisory protocol module is implemented by hardware or software module, and is also extensible. To configure the network apparatus with the supervisory function, the supervisory module 504 allows selectively loading the supervisory protocol on demand. The selected supervisory protocol is in compliance with, but not limited to, the supervisory control and data acquisition system (SCADA) and/or network management system (NMS). The system in accordance with the present invention may support both protocols for SCADA and NMS. The network apparatus may simultaneously initiate the two or more supervisory protocols.

Thus, the system may first load a first supervisory protocol module 505, a second supervisory protocol module 506, and a third supervisory protocol module 507. The number of the protocol modules is not limited by the patent scope of the invention. To meet a specific requirement, the supervisory module 504 is driven to initiate one or more of the protocol modules 505, 506 and 507 when receiving an instruction. The supervisory protocol may also be extended to other modules.

In the inserted management unit, the inserted data processing module 421, by software or firmware means, instructs the program loading module 501 to initiate a management or supervisory mechanism by the software driving module 502.

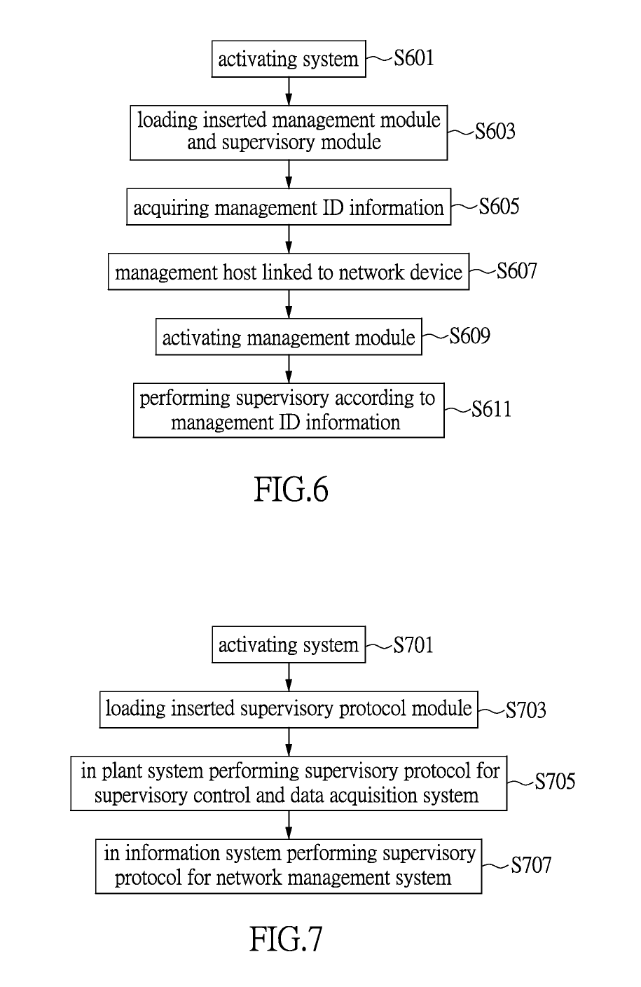

FIG. 6 shows a flow chart depicting the method for management and supervision in one embodiment of the present invention.

In the beginning, such as in step S601, the network apparatus with inserted management mechanism is activated. In the meantime, the network system initiates a management and supervision mechanism. Such as in step S603, in addition to installing the original functions, the apparatus loads an inserted management module and/or supervisory module of the inserted management unit.

The apparatus stays in connection with the network as it is activated. To identify every apparatus within the network, the management host or the management module installed in one system actively retrieves management identification information, e.g. from the broadcast message, with respect to every network apparatus over the network, such as in step S605. The management identification information is such as a device serial number of the apparatus, hostname, Internet address (IP), or media access control (MAC) address. The management host therefore identifies the apparatus according to the management identification information, such as in step S607. Next, in step S609, the apparatus activates its management module and then the management host establishes connection with the network apparatuses according to the connection setting. The connection setting preferably includes the address for the management host, the connection protocol, and security verification. A management mode is completely activated when the connection has been established.

At the same time or around the time of activating the management mode, the system in response to the requirement initiates a supervisory protocol. Such as in step S611, the supervisory host or the supervisory module installed in a system performs at least one supervisory protocol with respect to the non-manageable network apparatus in response to the management identification information with respect to every network apparatus with the inserted management mechanism. The management identification information is administrated by the administrator. When the apparatus is inserted with the management and supervisory mechanism, the network apparatus may operate under a specific supervisory protocol in order to respond to the system with a complied supervisory protocol.

FIG. 7 shows a flow chart depicting the method of the present invention.

In step S701, the network apparatus in the system is activated. The network apparatus initiates the inserted supervisory mechanism. The inserted program unit exemplarily renders many kinds of supervisory protocols. The apparatus responds the supervisory request made by the system for the purpose of supervision. After that, such as in step S703, the network apparatus accordingly loads one or more inserted supervisory protocol modules. The supervisory host or supervisory module performs the supervisory protocol. The apparatus transmits the supervisory information to the supervisory host in compliance with the required supervisory protocol.

For example, the network system with inserted management mechanism includes a plant system performing the protocol of supervisory control and data acquisition system (SCADA), such as in step S705. The network apparatus accordingly responds to the request made by the plant system with supervisory data. The system includes an information system performing the protocol of network management system (NMS), such as in step S707. The network apparatus accordingly responds to the information system with related data. It is noted that the order of step S705 and step S707 may not be limited by the patent scope of the invention.

An inserted supervisory mechanism is introduced to the non-manageable network apparatus, according to the present invention. The apparatus may flexibly operate under a corresponding supervisory protocol according to the network environment. The supervisory host is allowed to supervise the originally non-manageable network apparatus.

To sum up, to apply a management and supervisory mechanism to the non-manageable apparatus, an inserted management and supervisory mechanism is introduced to the non-manageable apparatus according to the present invention. In the network system with inserted management mechanism, the method is performed by hardware or software modules embedded in the non-manageable network apparatus. The inserted module may be a circuit module, or software-implemented module. When the system begins, the management host or supervisory host performs a management or supervisory procedure under a management or supervisory protocol. The host may successfully retrieve the information from the originally non-manageable network apparatus.

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. A network apparatus with an inserted management mechanism, wherein the network apparatus is a non-manageable network apparatus, and the network apparatus at least includes a micro-controlling module, an input-output interface module provided for connecting to a network, a network module configured to process network packets over a specific communication protocol, a memory module, and a power management module, characterized in that the network apparatus further comprising:
an inserted management unit, including an inserted program unit used to store a management and supervisory program, and an inserted data processing module used to process management and supervisory data;
wherein, the inserted program unit includes a program loading module and a software driving module, when the program loading module receives a signal of ready to initiate one or more program modules, the software driving module is called to initiate the one or more program modules.

2. The network apparatus of claim 1, wherein the inserted management unit is a chipset electrically connected to inner circuits of the network apparatus, in which the inserted data processing module is electrically connected with the micro-controlling module of the network apparatus.

3. The network apparatus of claim 2, wherein the program module includes a management module used to provide the non-manageable network apparatus a remote management service which allows the non-manageable network apparatus to be with remote management function.

4. The network apparatus of claim 2, wherein the program module includes a supervisory module used to provide the non-manageable network apparatus an inserted supervisory function.

5. The network apparatus of claim 1, wherein the inserted management unit is a software module installed in the network apparatus.

6. The network apparatus of claim 5, wherein the program module includes a management module used to provide the non-manageable network apparatus with a remote management service which allows the non-manageable network apparatus to have remote management function.

7. The network apparatus of claim 5, wherein the program module includes a supervisory module used to provide an inserted supervisory function to the non-manageable network apparatus.

8. The network apparatus of claim 1, wherein the inserted management unit is a circuit module integrated with the inserted data processing module and the micro-controlling module of the network apparatus.

9. The network apparatus of claim 8, wherein the program module includes a management module used to provide the non-manageable network apparatus with a remote management service which allows the non-manageable network apparatus to have remote management function.

10. The network apparatus of claim 8, wherein the program module includes a supervisory module used to provide the non-manageable network apparatus with an inserted supervisory function.

11. The network apparatus of claim 1, wherein the program module includes a management module used to provide the non-manageable network apparatus with a remote management service which allows the non-manageable network apparatus to have remote management function.

12. The network apparatus of claim 1, wherein the program module includes a supervisory module used to provide the non-manageable network apparatus with an inserted supervisory function.

13. The network apparatus of claim 12, wherein, a supervisory protocol supported by the supervisory module is a protocol of supervisory control and data acquisition system (SCADA) and/or a protocol of network management system (NMS).

14. A network system with an inserted management mechanism, providing a management means, a supervisory means, and at least one network apparatus with the inserted management mechanism according to claim 1, wherein the at least one network apparatus is connected with a facility performing the management means and the supervisory means over a network; wherein:
the management means providing a management program used to initiate a management interface for managing the at least one network apparatus with the inserted management mechanism; and
the supervisory means providing a supervisory program used to retrieve operating information of the network apparatus with the inserted management mechanism under a protocol in compliance with a protocol of supervisory control and data acquisition system and/or a protocol of simple network management.

15. A method of management and supervision, applied to the network system with the inserted management mechanism according to claim 14, wherein the method comprises:
activating the network system including at least one network apparatus with the inserted management mechanism;
loading a management module and/or a supervisory module within the inserted program unit of the network apparatus with the inserted management mechanism;
retrieving management identification information with respect to every network apparatus with the inserted management mechanism for identifying every network apparatus;
performing at least one supervisory protocol in response to the management identification information with respect to every network apparatus with the inserted management mechanism.

16. The method of claim 15, wherein the network system with the inserted management mechanism includes a plant system where a protocol of supervisory control and data acquisition system is performed; and an information system where a protocol of network management system is performed.
